(19) United States
(12) Patent Application Publication
(10) Pub. No.: US 2007/0223091 A1
(43) Pub. Date: Sep. 27, 2007

(54) System and method for laser speckle reduction

(75) Inventor: Benjamin Lowell Lee, Duncanville, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/390,950

(22) Filed: Mar. 27, 2006

(51) Int. Cl. G02B 5/30

(52) U.S. Cl. 359/494

(57) ABSTRACT

A system and method for reducing or eliminating speckle when using a coherent light source is provided. A refracting device comprising a birefringent material is positioned such that the refracting device intercepts the coherent light. The refracting device rotates thereby causing the ordinary and/or extraordinary beams to move. The human eye integrates the movement of the beams, reducing or eliminating laser speckle. The refracting device may include one or more optical devices formed of a birefringent material. Wave plates, e.g., a ½ wave plate, may be inserted between optical devices to cause specific patterns to be generated. Multiple optical devices having a different orientation of the horizontal component of the optical axis may also be used to generate other patterns. Furthermore, the refracting device may include an optical device having multiple sections of differing horizontal components of the optical axis.

### CROSS-REFERENCE TO RELATED APPLICATIONS

This application relates to the following co-pending and commonly assigned patent application: Ser. No. ______ (TI-61152), filed concurrently herewith, entitled System and Method for Laser Speckle Reduction, which application is are hereby incorporated herein by reference.

### TECHNICAL FIELD

The present invention relates generally to laser systems and, more particularly, to reduction of speckle in laser systems.

### BACKGROUND

Coherent light, such as light emitted by a laser, has increasingly been investigated for possible use in a wide variety of applications, including light sources for photography systems, projection systems, medical diagnostic systems, etc. Coherent light, generally, consists of light comprising in-phase light waves. As a result of the in-phase light waves, the use of coherent light may exhibit a phenomenon commonly referred to as speckle.

Generally, speckle occurs when coherent light is reflected off or transmitted through a rough surface. While most lenses and mirrors appear to have a smooth surface, the surfaces are actually rough, consisting of ridges and valleys when magnified. These ridges and valleys cause the coherent light to be scattered when reflected off or transmitted through the rough surface. This scattering causes an interference pattern to form in the light waves, and as a result, a viewer sees a speckled pattern, or a granular pattern. The speckled pattern typically comprises areas of lighter and darker patterns caused by the interference. The speckled patterns may be seen by a human eye as well as an optical sensor.

One attempt to solve the speckle problem is to use a rotating diffuser. The diffuser acts to diffuse the coherent light over a larger area, thereby illuminating the target or viewing surface more consistently. These diffuser systems, however, have several drawbacks. One such drawback is that the diffuser significantly reduces the light energy. The reduction of light energy results in less illumination of the target and/or less brightness/contrast of a projected image. In the field of projection systems, this drawback is particularly troublesome as the brightness and contrast that may be achieved by a projection system is one of the primary distinguishing factors.

Accordingly, there is a need for a system and method for eliminating or reducing speckle in systems using coherent light. In particular, there is a need for a system and method for eliminating or reducing speckle in projection systems using a coherent light source such as a laser.

### SUMMARY OF THE INVENTION

These and other problems are generally reduced, solved or circumvented, and technical advantages are generally achieved, by embodiments of the present invention, which provides a system and method for speckle reduction in laser systems.

In an embodiment of the present invention, a rotating refracting device comprising a birefringent material is utilized to refract light beams from a coherent light source. The rotating refracting device causes the light beams from the coherent light source to be constantly moving, thereby reducing the speckle effect.

In an embodiment, the refracting device is a rotating circular shaped piece of birefringent material positioned such that a major surface of the birefringent material is normal to the light beam. In this embodiment, the coherent light is projected through the refracting device, and because the glass is rotating, the light beam moves in a pre-defined pattern, thereby reducing the speckle effect.

In an embodiment, the refracting device comprises a plurality of optical devices, wherein each optical device comprises a birefringent material. The horizontal components of the optical axes of the optical devices may have differing orientations, e.g., 180 degrees offset, to create varying patterns. A wave plate, e.g., a ½ wave plate, may be placed between two or more of the optical devices to create other patterns.

In another embodiment, the refracting device comprises one or more optical devices such that the optical devices comprise a plurality of sections of a birefringent material, wherein the horizontal component of the optical axis of two or more of the sections differ. A wave plate, e.g., a ½ wave plate, may be placed between two or more of the optical devices to create other patterns.

In another embodiment, the refracting device is used in a projection system in which the coherent light from the refracting device is modulated onto a viewing surface to form an image. The modulator may be, for example, a DMD chip. The projection system may include other components, such as light sinks, projection optics, or the like.

It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a system diagram of a laser projection system utilizing a refracting device in accordance with an embodiment of the present invention;

FIG. 2 is a side view of a refracting device in accordance with an embodiment of the present invention;

FIGS. 3a-3d are schematic diagrams illustrating an operation of the refracting device in accordance with an embodiment of the present invention;

FIG. 4 is a plan view of a resulting pattern of light that may be generated utilizing a refracting device in accordance with an embodiment of the present invention;

FIG. 5 is a system diagram of a laser projection system utilizing a refracting device in accordance with an embodiment of the present invention;

FIGS. 6a-b illustrate a refracting device and its operation in accordance with an embodiment of the present invention;

FIGS. 7a-b illustrate yet another refracting device and its operation in accordance with an embodiment of the present invention;

FIGS. 8a-c illustrate yet another refracting device and its operation in accordance with an embodiment of the present invention;

FIGS. 9a-b illustrate yet another refracting device and its operation in accordance with an embodiment of the present invention;

FIGS. 10a-b illustrate yet another refracting device and its operation in accordance with an embodiment of the present invention; and

FIGS. 11a-b illustrate yet another refracting device and its operation in accordance with an embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

It should be noted that embodiments of the present invention are discussed in terms of a laser projection system for illustrative purposes only and that embodiments of the present invention may be utilized in any type of system, particularly systems using a monochromatic coherent light source, in which speckle may be a problem. Examples of systems in which embodiments of the present invention may be useful include projection systems, illumination systems, diagnostic systems, other systems using laser light, and the like.

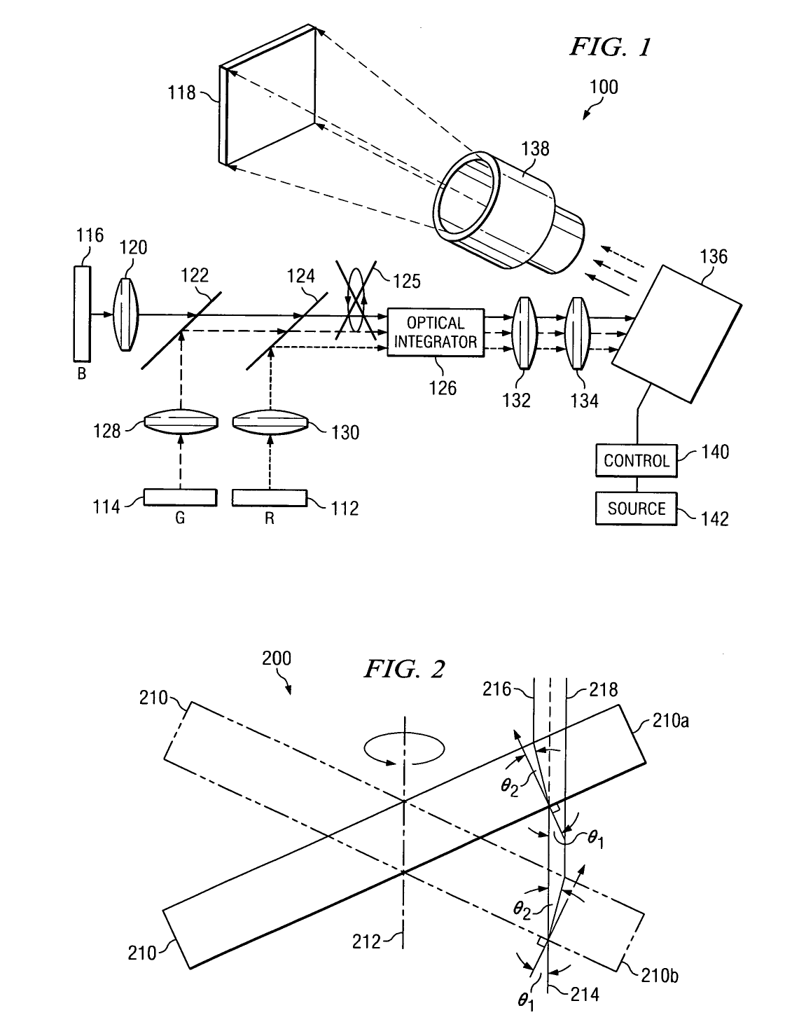

FIG. 1 is a configuration diagram illustrating selected components of a projection display system 100 in accordance with an embodiment of the present invention. The projection display system 100 includes various components that define an optical path between coherent light sources 112, 114, and 116 and display screen 118. Coherent light sources 112, 114, and 116 may be, for example, a red laser, a green laser, and a blue laser, respectively. The light can be applied sequentially by turning on and off each of the red, green, and blue lasers, or by turning on and off any combination of lasers.

Lenses 120, 128, and 130 as well as filters 122 and 124 are positioned to direct coherent light from coherent light sources 112, 114, and 116 toward an optical integrator 126, which is configured to direct the coherent light toward a light modulator 136 via lenses 132 and 134. Generally, the light modulator 136 selectively directs the light from the coherent light sources 112, 114, and 116 to one or more projection lenses, such as projection lens 138, which projects the image onto a display screen 118. One example of a suitable light modulator 136 is a digital micromirror device (DMD) produced by Texas Instruments of Dallas, Tex. Other components, however, may be used. The operation data is provided by a timing and control circuit 140 as determined from signal processing circuitry according to an image source 142. The timing and control circuit 140 may also be electrically coupled to other devices, such as one or more lenses, coherent light sources, projection optics, or the like.

A refracting device 125 is positioned between the coherent light sources 112, 114, and 116 and the light modulator 136. While the refracting device 125 may be positioned before, after, or between the one or more filters 122 and 124, lenses 120, 128, 130, 132, and 134, it is preferred that the refracting device 112 be positioned between the coherent light sources 112, 114, and 116 and the first of the one or more lenses 132 and 134, as illustrated in FIG. 1. Generally, the refracting device 125 translates the coherent light from the coherent light sources 112, 114, and 116 such that a longitudinal axis of the incoming coherent light is parallel and not co-linear with the longitudinal axis of the outgoing coherent light. It should also be noted that while it is preferred that the refracting device 125 be positioned on the illumination side of the light modulator 136, the refracting device 125 may be positioned on the projection side of the light modulator, such as between the light modulator 136 and the projection lens 138.

One skilled in the art will realize that translation of the coherent light essentially relocates the speckle pattern, but does not eliminate it. To reduce or eliminate the observable speckle pattern, the refracting device 125 changes the amount of offset and/or the direction of offset at a sufficiently high rate to allow the human eye to integrate the changing speckle pattern. Because the speckle pattern is non-uniform (random light and dark regions), but is changing in time, the human eye integrates the speckle pattern over time, thereby creating a smoother, more uniform image. The refracting device 125 will be described in greater detail below with reference to FIGS. 2-4.

In operation, light from a blue coherent light source 116 is transmitted via lens 120 through filter 122 and filter 124 to optical integrator 126. Likewise, light from a green coherent light source 114 passes through lens 128 and is then reflected from filter 122 and transmitted through filter 124 to optical integrator 126. Light from a red coherent light source 112 passes through lens 130 and is then reflected from filter 124 to optical integrator 126.

Light from optical integrator 126 is transmitted to (and through) relay lenses 132 and 134, from there it is directed to the light modulator 136. The light modulator 136 selectively directs light to the projection lens 138 and on to the display screen or other display medium 118. The operation data is provided by the timing and control circuit 140 as determined from signal processing circuitry according to the image source 142.

It should be noted that the laser projection system 100 is provided as an illustrative embodiment of the present invention only and is not meant to limit other embodiments of the invention. Not all components of a projection system have been shown, but rather the elements necessary for one of ordinary skill in the art to understand concepts of the present invention are illustrated. For example, the projection system may include additional optical devices (e.g., mirrors, lenses, etc.), additional electronics (e.g., power supplies, sensors, etc.), light sinks, additional light sources, and/or the like. Likewise, one or more components illustrated in FIG. 1 may be removed. For example, the projection system may utilize fewer coherent light sources, lenses, filters, and/or the like. Furthermore, one of ordinary skill in the art will realize that numerous modifications may be made to the projection system 100 within the scope of the present invention.

FIG. 2 is an example of a refracting device 200 in accordance with an embodiment of the present invention. The refracting device 200 may be used as a refracting device 125 of the system illustrated in FIG. 1. The refracting device 200 illustrates a circular disc 210 in a first position 210a, as indicated by the rectangle having a solid line, and in a second position 210b, as indicated by the rectangle having a dashed line. The second position 210b represents the circular disc 210 in the first position 210a that has been rotated 180° about axis 212. Shapes other than the circular disc illustrated in FIG. 2 may be used.

In an embodiment, the rotation axis 212 is substantially parallel to the direction of travel of coherent light 214. In this embodiment, the circular disc 210 is positioned such that the coherent light intersects the planar surface of the circular disc 210 at an oblique angle, i.e., the planar surface of the circular disc 210 is not perpendicular to the coherent light.

As illustrated in FIG. 2, refraction causes the circular disc 210 to offset the coherent light in accordance with Snell's formula:
N₁sin(θ₁)=N₂sin(θ₂),

wherein
N₁ is the refractive index of the medium the light is leaving (e.g., air);
θ₁ is the incident angle between the light ray and the normal to the major surface of the circular disc 210;
N₂ is the refractive index of the circular disc 210; and
θ₂ is the refractive angle between the light ray and the normal to the major surface of the circular disc 210.

Accordingly, when the circular disc 210 is in the first position 210a, the coherent light 214 is offset by the refractive qualities of the circular disc 210 to position 216. Likewise, when the circular disc 210 is in the second position 210b, the coherent light 214 is offset by the refractive qualities of the circular disc 210 to position 218.

The circular disc 210 is preferably a highly transparent medium characterized by little or no diffusion. In an embodiment, the circular disc 210 comprises optical-quality or lens-quality material with substantially parallel major surfaces coated with an anti-reflective coating to reduce light energy loss.

One skilled in the art will realize that the composition of the circular disc 210, the thickness of the circular disc 210, and the tilt angle between the axis of rotation 212 and the major surface of the circular disc 210 may be altered to suit a particular purpose and/or design. Generally, a material having a higher refractive index will offset the coherent light more than a material having a smaller refractive index, and a thicker circular disc 210 offsets the coherent light 214 more than a thinner disc made of the same material. Similarly, the tilt angle may be increased to create a larger offset.

The amount of offset that is desirable in a given environment depends upon many factors. For example, the roughness of the projection surface, wavelength of the coherent light, distance of the observer from the viewing surface, the type (e.g., still or action) of image being displayed, and the like will all affect how observable the speckle is in a given environment and, thus, will affect the design of the refracting device.

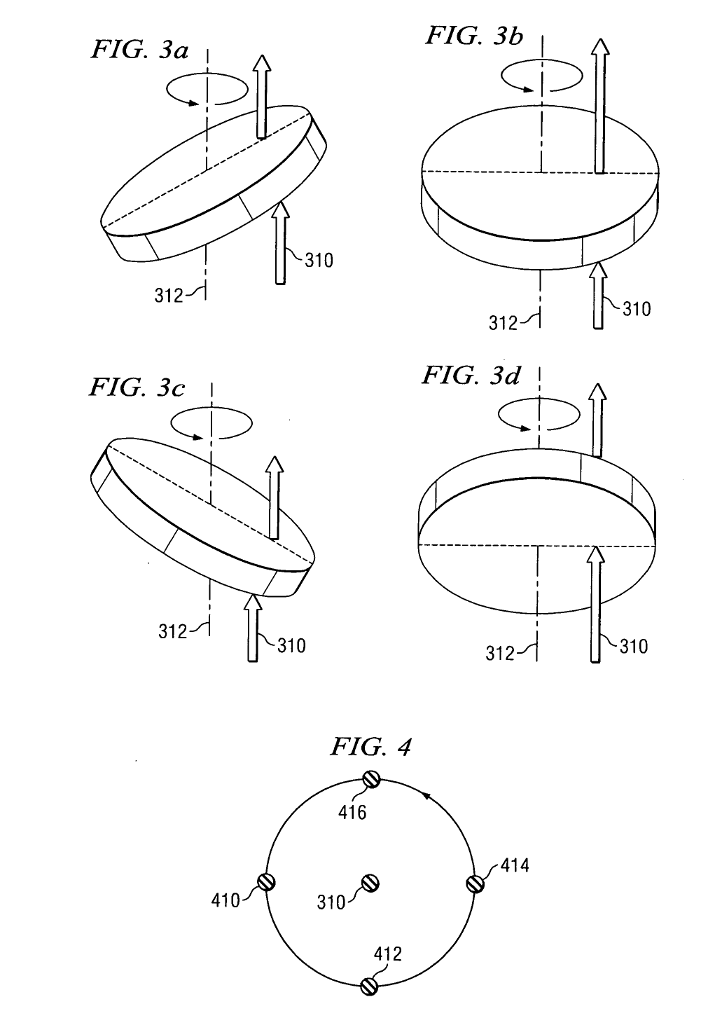

FIGS. 3a-3d illustrate an operation of the circular disc 210 in accordance with an embodiment of the present invention. FIG. 4 is a plan view of the pattern generated by the operation illustrated in FIGS. 3a-3d on a viewing surface relative to an originating light source. As discussed above and illustrated in FIGS. 3a-3d, the circular disc 210 is positioned such that a major surface is not normal to the axis of an originating light source 310 and is rotated about an axis 312 parallel to the axis of the originating light source 310.

Thus, when the circular disc 210 is in the position illustrated in FIG. 3a, the originating light source 310 is refracted to position 410 relative to the originating light source 310 as illustrated in FIG. 4. Similarly, position 412 of FIG. 4 represents the position of the outgoing light beam when the circular disc 210 is in the position illustrated in FIG. 3b; position 414 of FIG. 4 represents the position of the outgoing light beam when the circular disc 210 is in the position illustrated in FIG. 3c; and position 416 of FIG. 4 represents the position of the outgoing light beam when the circular disc 210 is in the position illustrated in FIG. 3d. As discussed above, it has been found that the circular rotation reduces and/or eliminates the amount of visible speckle.

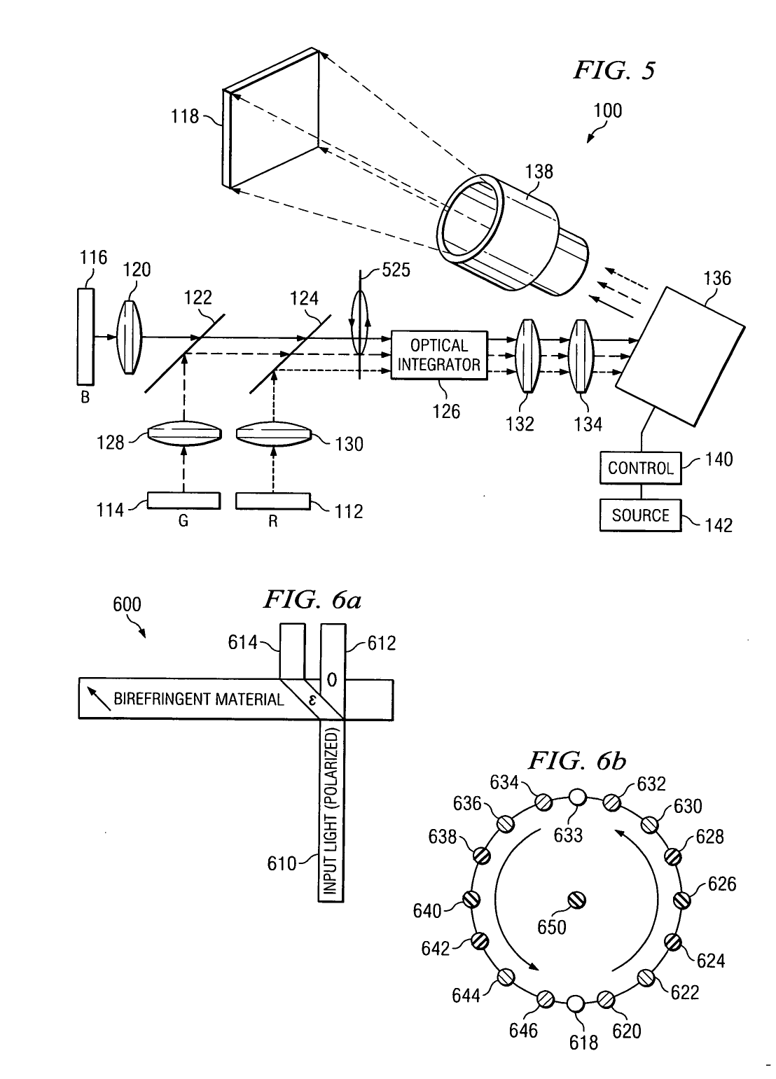

FIG. 5 is a system diagram of an embodiment of the present invention utilizing a refracting device comprising birefringent material in accordance with an embodiment of the present invention. FIG. 5 is similar to FIG. 1, wherein like reference numerals refer to like elements, except that refracting device 125 of FIG. 1 has been replaced with refracting device 525 in FIG. 5. The refracting device 525 comprises a birefringent material and may be positioned such that a major surface is perpendicular to the longitudinal axis of the coherent light. Generally, a birefringent material divides an incoming beam of light into two beams of outgoing light (i.e., an extraordinary beam and an ordinary beam of light). Because the birefringent material creates an extraordinary beam and an ordinary beam of light from the single incoming beam of light, the refracting device 525 may be positioned such that a major surface of the refracting device 525 is substantially normal to the incoming beam of light, in accordance with a preferred embodiment of the present invention. The refracting device 525 may be positioned, however, such that an oblique angle is formed between a major surface of the refracting device 525 and the coherent light beam. Various embodiments of the refracting device 525 are disclosed below with reference to FIGS. 6a-11b.

FIG. 6a illustrates a refracting device 600 that may be used as the refracting device 525 of the system illustrated in FIG. 5 in accordance with an embodiment of the present invention. The refracting device 600 comprises a circular disk formed of a birefringent material. As illustrated in FIG. 6a, birefringent materials separate an incoming polarized beam 610 of light into an ordinary beam 612 and an extraordinary beam 614 of light. A longitudinal axis of the ordinary beam 612 substantially coincides with a longitudinal axis of the incoming beam 610. The extraordinary beam 614, however, diverges from the incoming beam 610 by an angle determined by the refractive index of the birefringent material. As a result, a longitudinal axis of the extraordinary beam 614 exiting the refracting device 600 is substantially parallel to the longitudinal axis of the incoming beam 610 of light, but is not co-linear.

The amount the extraordinary beam 614 is offset from the ordinary beam 612 depends upon the refractive index of the birefringent material and the thickness of the disk. It should be noted that although the preferred embodiment comprises a circular disk, other shapes, such as irregular polygons, squares, hexagons, octagons, rectangles, or the like, may also be used. Suitable birefringent materials include calcite, rutile (TiO₂), yttrium vanadate (YVO₄), or the like.

In an embodiment, the refracting device 600 is rotated about a rotational axis substantially normal to a major surface of the refracting device 600, and such that the rotational axis is substantially parallel to the longitudinal axis of the incoming beam of light. In this manner, the ordinary beam 612 remains in the substantially same position, but varying in brightness, while the extraordinary beam 614 varies its position while also varying in brightness.

FIG. 6b illustrates the movement of the ordinary beam 612 and extraordinary beam 614 exiting the refracting device 600 of FIG. 6a, in accordance with an embodiment of the present invention. It should be noted that the pattern shown in FIG. 6b assumes a linearly polarized light source. A randomly polarized light source may generate a different pattern. Reference numerals 618-646 represent the sequential movement of the extraordinary beam 614, and reference numeral 650 represents the ordinary beam 612. As illustrated, the ordinary beam 612 remains substantially stationary, while the extraordinary beam 614 moves in a substantially circular manner about the ordinary beam 612.

Furthermore, it should be noted that the intensity of the ordinary beam 612 and the extraordinary beam 614 varies as the refracting device 600 is rotated. The varying intensity of the extraordinary beam 614 is illustrated in FIG. 6b, wherein the darker the circle, the brighter the extraordinary beam 614. For example, starting when the extraordinary beam 614 is at position 618, the ordinary beam 612 is at maximum brightness while the extraordinary beam is at its dimmest. In this position, substantially all of the light energy is being directed to the ordinary beam 612 and substantially none of the light is being directed to the extraordinary beam 614. This occurs primarily due to the polarization of the incoming beam and the optical axis of the birefringent material.

As the refracting device 600 rotates, the extraordinary beam 614 rotates from position 618 to positions 620, 622, and 624 until the extraordinary beam 614 reaches position 626. As indicated by the shading in FIG. 6b, the extraordinary beam 614 gradually increases in brightness as it rotates from position 618 to position 626, where the extraordinary beam 614 is at maximum brightness. When the extraordinary beam 614 is at position 626, the ordinary beam 612 is at its minimum brightness.

Thereafter, the extraordinary beam 614 sequentially proceeds from position 626 to successive positions 628, 630, and 632, decreasing in intensity until the extraordinary beam 614 reaches its minimum intensity again at position 633. While the extraordinary beam 614 decreases in intensity as it proceeds from position 626 to position 633, the ordinary beam 612 increases in intensity, reaching its maximum intensity when the extraordinary beam 614 reaches position 633.

This process is repeated as the extraordinary beam 614 proceeds from position 633 to positions 634, 636, 638, and 640, where the extraordinary beam 614 reaches its maximum intensity and the ordinary beam 612 reaches its minimum intensity, and from position 640 to positions 642, 644, 646, and back to 618, wherein the extraordinary beam 614 reaches its minimum intensity and the ordinary beam 612 reaches its maximum intensity.

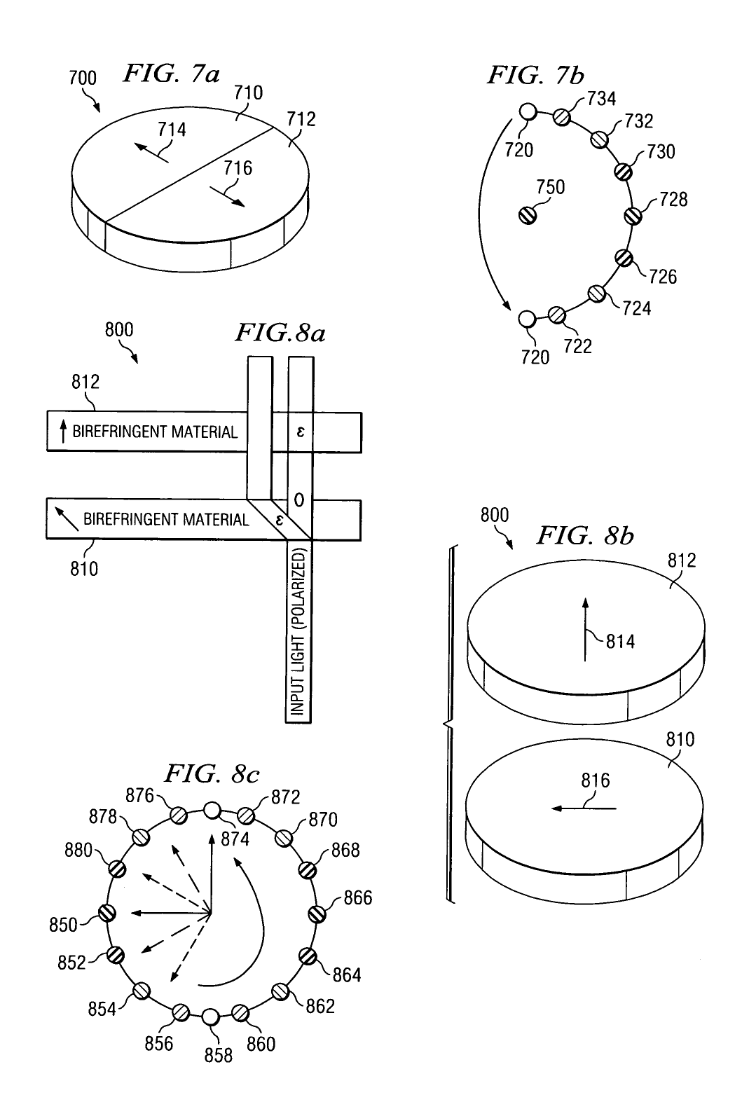

FIG. 7a illustrates another embodiment of a refracting device 700 that may be used as the refracting device 525 of FIG. 5, in accordance with an embodiment of the present invention. In this embodiment, the refracting device 700 comprises a first section 710 and a second section 712, which are approximately equal halves arranged such that the horizontal component of the optical axis of the first section 710 is rotated 180 degrees relative to the horizontal component of the optical axis of the second section 712. In FIG. 7a, the horizontal component of the optical axes of the first section 710 and the second section 712 are represented by arrows 714 and 716, respectively.

FIG. 7b illustrates the movement of the ordinary beam 612 and extraordinary beam 614 (see FIG. 6a) on a display surface in accordance with an embodiment of the present invention. It should be noted that the pattern shown in FIG. 7b assumes a linearly polarized light source. A randomly polarized light source may generate a different pattern. The movement of the extraordinary beam 614 in this embodiment is similar to the movement of the extraordinary beam 614 through positions 618-633 discussed above with reference to FIG. 6b corresponding to positions 720-734 of FIG. 7b. However, the extraordinary beam 614 of the embodiment illustrated in FIG. 7b proceeds from position 734 back to the beginning position 720 due to the extraordinary beam 614 crossing the boundary between the first section 710 and the second section 712 (see FIG. 7a). This shift is due to the opposing directions of the horizontal component of the optical axes of the first section 710 and the second section 712.

FIG. 8a illustrates yet another embodiment of a refracting device 800 that may be used as the refracting device 525 of FIG. 5 in accordance with an embodiment of the present invention. In this embodiment, two optical devices, a first disk 810 and a second disk 812, are arranged such that an incoming beam sequentially passes through the first disk 810 and then the second disk 812. Each of the first disk 810 and the second disk 812 comprises a birefringent material such as that discussed above with reference to FIG. 6a.

In this embodiment, however, the first disk 810 and the second disk 812 are separated by a first distance and the horizontal component 814 of the optical axis of the first disk 810 is perpendicular to the horizontal component 816 of the optical axis of the second disk 812. This is illustrated in FIG. 8b, wherein it is shown that the horizontal component 814 of the optical axis of the first disk 810 is perpendicular to the horizontal component 816 of the optical axis of the second disk 812. Thus, the beams illustrated in FIG. 8a passing through the second disk 812 do not necessarily pass straight through the second disk 812, but rather the extraordinary beam is deflected into the page.

FIG. 8c illustrates a pattern formed by the refracting device 800 in accordance with an embodiment of the present invention. It should be noted that the pattern shown in FIG. 8c assumes a linearly polarized light source. A randomly polarized light source may generate a different pattern. As illustrated, two beams will move in a substantially circular motion with one beam being approximately 90 degrees behind the other. Accordingly, when a first beam is at position 850, the second beam will be at position 874. At this position, however, the first beam will be at maximum intensity and the second beam will be at minimum intensity, making it appear as if there is a single beam at position 850.

As the first disk 810 and second disk 812 rotate, the two beams will rotate in unison on the display surface. The first beam proceeds from position 850 to positions 852, 854, 856 while steadily decreasing in intensity until it reaches its minimum intensity at position 858. The second beam, 90 degrees behind the first beam, proceeds from position 874 to positions 876, 878, 880 steadily increasing in intensity until it reaches and its maximum intensity at position 850. At this position, the second beam is at its maximum intensity and the first beam is at its minimum intensity, making it appear as if there is a single beam.

Thereafter, the first beam proceeds from position 858 to positions 860, 862, 864 until it again reaches its maximum intensity at position 866. Meanwhile, the second beam, 90 degrees behind the first beam, proceeds from position 850 to positions 852, 854, 856 steadily decreasing in intensity until it reaches and its minimum intensity at position 858. The first beam continues moving in this circular manner through points 868-880 and the second beam continues moving in this manner through points 860-872.

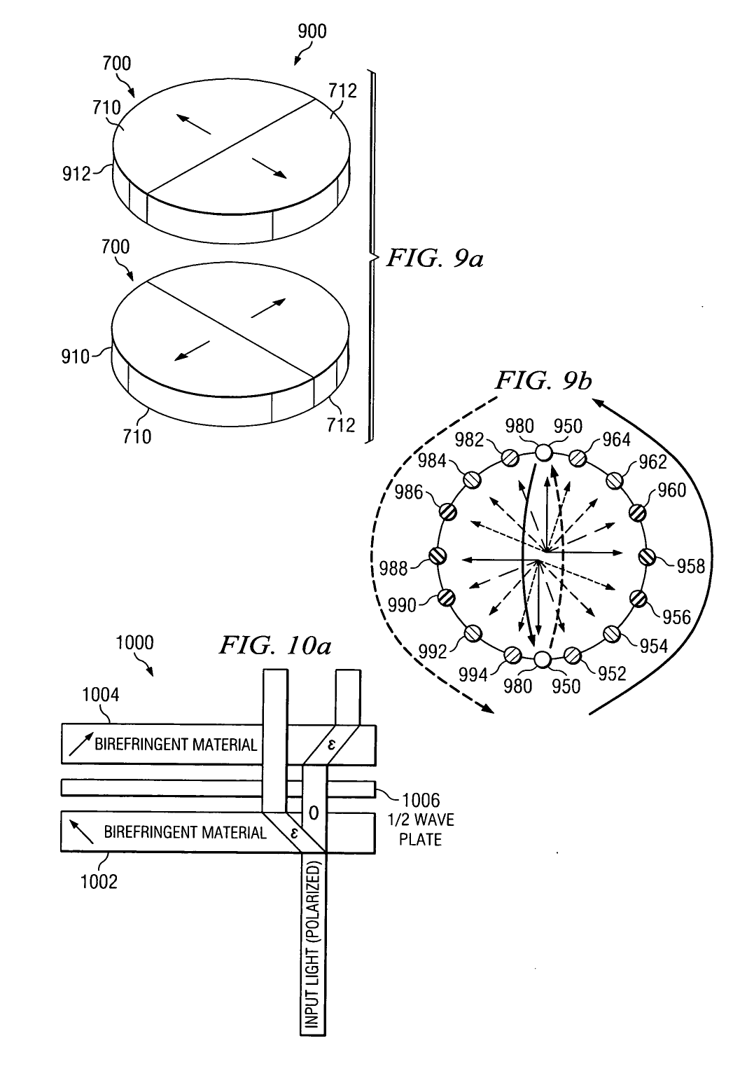

FIG. 9a illustrates yet another embodiment of a refracting device 900 that may be used as the refracting device 525 of FIG. 5 in accordance with an embodiment of the present invention. In this embodiment, the refracting device 900 comprises two optical devices, a first disk 910 and a second disk 912, each comprising a disk as discussed above with reference to FIG. 7a and arranged such that an incoming beam of light passes sequentially through both disks. As noted above with reference to FIG. 7a, each of the refracting devices 700 comprises a first section 710 and a second section 712, which are approximately equal halves arranged such that the horizontal component of the optical axis of the first section 710 is rotated 180 degrees relative to the horizontal component of the optical axis of the second section 712. In the embodiment illustrated in FIG. 9a, the horizontal components of the optical axes of the second disk 912 is rotated 90 degrees relative to the horizontal components of the optical axes of the first disk 910.

FIG. 9b illustrates the movement of the light beams that may be generated using the refracting device 900 in accordance with an embodiment of the present invention. It should be noted that the pattern shown in FIG. 9b assumes a linearly polarized light source. A randomly polarized light source may generate a different pattern. The movement of a first beam, illustrated by the solid bold arrows, in this embodiment is similar to the movement of the extraordinary beam 614 through positions 618-633 discussed above with reference to FIG. 6b, wherein positions 618-632 correspond to positions 950-964, respectively. However, the first beam proceeds from position 964 back to position 950, wherein the movement is repeated.

The second beam proceeds in a similar manner, starting at position 980 and proceeding through positions 982-994, where the second beam returns to the starting position 980. The position of the second beam is offset 90 degrees relative to the position of the first beam. For example, when the first beam is at position 950, its minimum, the second beam is at position 988, its maximum. When the first beam proceeds to its maximum position 958, the second beam proceeds to its minimum position 980. At this point, the second beam proceeds to the opposing side of the circle, which is still 90 degrees offset from the first beam at position 958. As the first beam proceeds to its minimum position 950, the second beam proceeds to its maximum position 988. At this point, the first beam proceeds to the opposing side of the circle, wherein the movement is repeated.

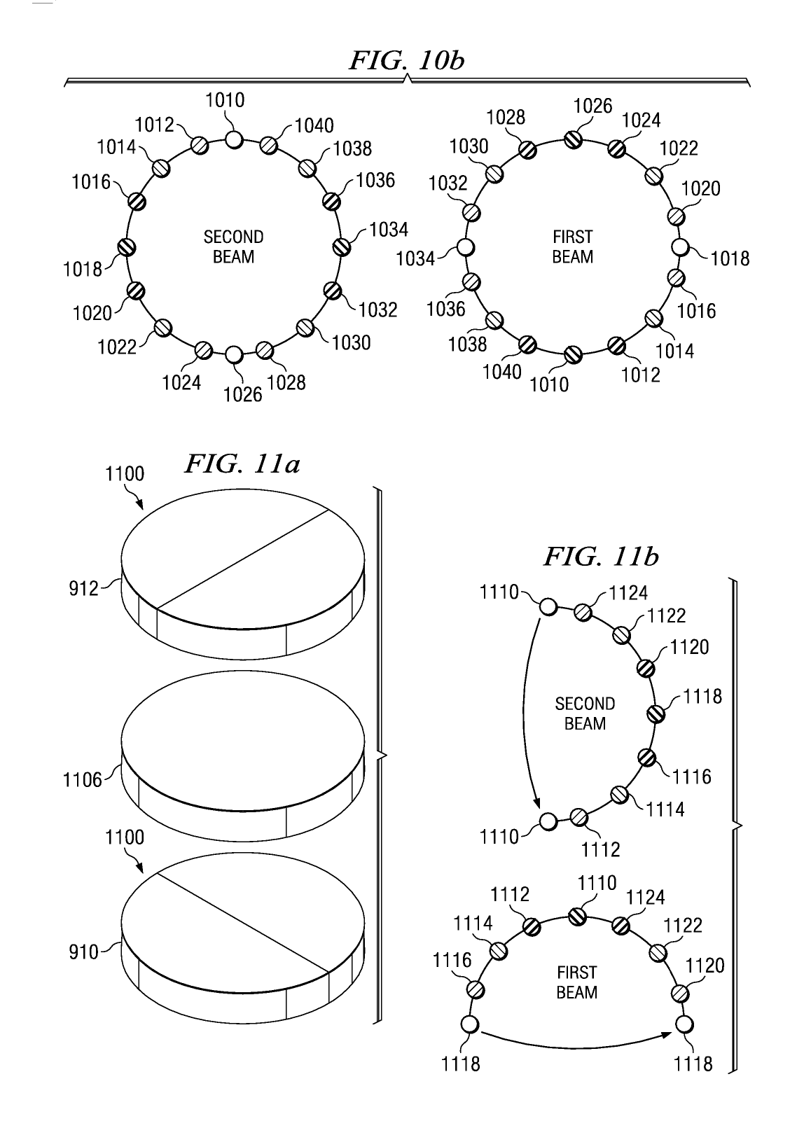

FIG. 10a illustrates yet another refracting device 1000 that may be used as the refracting device 525 of FIG. 5 in accordance with an embodiment of the present invention. In this embodiment, the refracting device 1000 preferably comprises a plurality of optical devices, e.g., a first disk 1002 and a second disk 1004, each preferably being formed of a birefringent material and arranged such that an angle between the horizontal components of the optical axes of the first disk 1002 and the second disk 1004 is approximately 180 degrees. Between the first disk 1002 and the second disk 1004 is a ½ wave plate 1006. Generally, the ½ wave plate rotates the linear polarization 90 degrees and should be selected based upon the wavelength of the incoming light. It should be noted that in this embodiment it may be desirable to utilize a different ½ wave plate for each color light source such that the ½ wave plate may be selected based upon the wavelength of each respective color light source. Accordingly, it may be desirable to utilize multiple refracting devices 1000 corresponding to each wavelength of the respective coherent light source.

FIG. 10b illustrates a pattern that may be obtained using the refracting device 1000 of FIG. 10a in accordance with an embodiment of the present invention. It should be noted that the pattern shown in FIG. 10b assumes a linearly polarized light source. A randomly polarized light source may generate a different pattern. The bottom figure represents the movement of a first beam and the top figure represents the movement of the second beam. In operation, however, the movement of the second beam illustrated in the top figure is superimposed on the movement of the first beam illustrated in the bottom figure. The reference numerals 1010-1040 represent the sequential order of movement of each beam, wherein like reference numerals indicate the relative position of each beam at a given point in time.

For example, when the first beam is at its maximum brightness at position 1010, the second beam is at its minimum brightness approximately 180 degrees offset at position 1010. As the first and second beams proceed in a circular pattern, the first beam and the second beam maintain an offset of 180 degrees.

FIG. 11a illustrates yet another refracting device 1100 that may be used as the refracting device 525 of FIG. 5 in accordance with an embodiment of the present invention. The refracting device 1100 is similar to the refracting device 900 illustrated in FIG. 9a, wherein like reference numerals refer to like elements, with a ½ wave plate 1106 inserted between the first disk 910 and the second disk 912.

FIG. 11b illustrates a pattern that may be obtained using the refracting device 1100 of FIG. 11a in accordance with an embodiment of the present invention. Similar to FIG. 10b, the bottom figure represents the movement of a first beam, and the top figure represents the movement of the second beam. In operation, however, the movement of the second beam illustrated in the top figure is superimposed on the movement of the first beam illustrated in the bottom figure. The reference numerals 1110-1124 represent the sequential order of movement of each beam, wherein like reference numerals indicate the relative position of each beam at a given point in time.

For example, when the first beam is at its maximum brightness at position 1110, the second beam is at its minimum brightness at position 1110. It should be noted that in this embodiment, a beam of light is never shown in the lower left quadrant.

The embodiments discussed above illustrate a few of the configurations that may be used in accordance with embodiments of the present invention. Other configurations, however may be used to reduce the effects of laser speckle. For example, additional or different wave plates may be used, different combinations and orientations of birefringent disks may be used, and the like.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A projection system comprising:
a coherent light source configured to emit a beam of light along a first axis; and
a refracting device positioned to intercept the beam of light, the first refracting device comprising a birefringent material.

2. The projection system of claim 1, wherein the refracting device comprises a plurality of optical devices, each optical device comprising a birefringent material.

3. The projection system of claim 2, wherein the refracting device further comprises a wave plate between two of the optical devices.

4. The projection system of claim 1, wherein the refracting device comprises a first optical device comprising a birefringent material, the first optical device having a first section and a second section, the first section having a first horizontal component of an optical axis and the second section having a second horizontal component of an optical axis, the first horizontal component being in a substantially opposing direction as the second horizontal component.

5. The projection system of claim 4, wherein the refracting device further comprises a second optical device comprising a birefringent material, the second optical device having a third section and a fourth section, the third section having a third horizontal component of an optical axis and the fourth section having a fourth horizontal component of an optical axis, the third horizontal component being in a substantially opposing direction as the fourth horizontal component.

6. The projection system of claim 5, wherein the refracting device further comprises a wave plate between the first optical device and the second optical device.

7. The projection system of claim 1, wherein the refracting device is configured to rotate about a first axis, the first axis being parallel and non-collinear with a longitudinal axis of a coherent light beam.

8. A projection system comprising:
one or more coherent light sources configured to emit one or more coherent light beams;
a refracting device positioned to intercept the one or more coherent light beams, the refracting device comprising one or more optical devices comprising a birefringent material;
a modulator positioned to receive refracted light and to project modulated light toward a viewing surface; and
projection optics configured to project the modulated light onto the viewing surface.

9. The projection system of claim 8, wherein the refracting device further comprises a wave plate between two of the optical devices.

10. The projection system of claim 8, wherein the refracting device comprises a first optical device comprising a birefringent material, the first optical device having a first section and a second section, the first section having a first horizontal component of an optical axis and the second section having a second horizontal component of an optical axis, the first horizontal component being in a substantially opposing direction as the second horizontal component.

11. The projection system of claim 10, wherein the refracting device further comprises a second optical device comprising a birefringent material, the second optical device having a third section and a fourth section, the third section having a third horizontal component of an optical axis and the fourth section having a fourth horizontal component of an optical axis, the third horizontal component being in a substantially opposing direction as the fourth horizontal component.

12. The projection system of claim 10, wherein the refracting device further comprises a wave plate between the first optical device and the second optical device.

13. The projection system of claim 8, wherein the refracting device is configured to rotate about a first axis, the first axis being parallel with a longitudinal axis of the coherent light beams.

14. A method of forming an image, the method comprising:
emitting a coherent light along a first axis;
rotating a refracting device along a second axis, the refracting device comprising a birefringent material and intersecting the first axis; and
generating an image on a viewing surface with the coherent light from the refracting device.

15. The method of claim 14, wherein the refracting device comprises a plurality of optical devices, each optical device comprising a birefringent material.

16. The method of claim 15, wherein the refracting device further comprises a wave plate between two of the optical devices.

17. The method of claim 14, wherein the refracting device comprises a first optical device comprising a birefringent material, the first optical device having a first section and a second section, the first section having a first horizontal component of an optical axis and the second section having a second horizontal component of an optical axis, the first horizontal component being in a substantially opposing direction as the second horizontal component.

18. The method of claim 17, wherein the refracting device further comprises a second optical device comprising a birefringent material, the second optical device having a third section and a fourth section, the third section having a third horizontal component of an optical axis and the fourth section having a fourth horizontal component of an optical axis, the third horizontal component being in a substantially opposing direction as the fourth horizontal component.

19. The method of claim 18, wherein the refracting device further comprises a wave plate between the first optical device and the second optical device.

20. The method of claim 14, wherein the refracting device is configured to rotate about the first axis, the first axis being parallel and non-collinear with a longitudinal axis of a coherent light beam.

21. A projection system comprising:
a coherent light source configured to emit a beam of light along a first axis; and
a first refracting device positioned to intercept the beam of light, the first refracting device comprising a birefringent material.
a second refracting device displaced from the first refracting device, wherein the second refracting device is positioned to intercept the beam of light after the first refracting device, and
the beam of light is divided into non-collinear beams after emerging from the first refracting device.

22. The projection system of claim 21, wherein at least one of the non-collinear beams does not pass straight through the second refracting device.

23. The projection system of claim 21, wherein rotating the first and second refracting device rotates the non-collinear beams.
